(19) United States
(12) Patent Application Publication
(10) Pub. No.: US 2023/0046056 A1
(43) Pub. Date: Feb. 16, 2023

(54) FINGERPRINT SENSING MODULE

(71) Applicant: Fingerprint Cards Anacatum IP AB, Göteborg (SE)

(72) Inventors: Hanna SKÅRBRATT, GÖTEBORG (SE); Pontus JÄGEMALM, LERUM (SE); Mats SLOTTNER, LERUM (SE)

(73) Assignee: Fingerprint Cards Anacatum IP AB, Göteborg (SE)

(21) Appl. No.: 17/798,739

(22) PCT Filed: Feb. 8, 2021
(86) PCT No.: PCT/SE2021/050091

§ 371 Date: Aug. 10, 2022

(30) Foreign Application Priority Data
Feb. 17, 2020 (SE) 2050174-8

(51) Int. Cl. G06V 40/13; G06V 40/12; G06V 40/50; G06V 40/60; G06F 21/32; G06K 19/07

(52) U.S. Cl. CPC G06V 40/1306; G06V 40/1365; G06V 40/50; G06V 40/63; G06F 21/32; G06K 19/0718

(57) ABSTRACT

In an aspect, a fingerprint sensing module configured to be integrated in a device for biometric authentication of a user of the device is provided. The fingerprint sensing module comprises a fingerprint sensor and a display configured to display information to the user; the display comprising pixel elements being arranged in the display such that the pixel elements do not obscure a sensing area of the fingerprint sensor in which area the fingerprint sensor is being configured to detect a finger of the user.

### TECHNICAL FIELD

The present disclosure relates to a fingerprint sensing module configured to be integrated in a device for biometric authentication of a user of the device, and a method of the device comprising the fingerprint sensing module of displaying information to a user based on biometric data of the user.

### BACKGROUND

To improve security and convenience, fingerprint sensors are integrated in many devices that do not have display capability or in other way of communicating with a user, such as locks, electronic luggage tags, smartcards, etc. Such devices would benefit from being able to give the user feedback about success of authentication or to provide the user with a code that can be used for further secure access based on a successful authentication.

A device such as a smart card being equipped with a fingerprint sensor and a display function would solve this problem and allow for integration into the types of devices mentioned above. Further, in case of smart credit cards, it is of interest to be able to provide for fingerprint activated dynamic Card Verification Value (CVV) code or Card Verification Code (CVC), i.e. new generated CVVs/CVCs at regular intervals in order to prevent card-not-present fraud.

However, such solutions require additional components and thus a relatively great space which is not typically available, or at last not desired, in physically small devices such as smartcards.

### SUMMARY

One object is to solve, or at least mitigate, this problem in the art and thus to provide an improved approach of combining biometric sensing and displaying of information on a device.

This object is attained in a first aspect by a fingerprint sensing module configured to be integrated in a device for biometric authentication of a user of the device. The fingerprint sensing module comprises a fingerprint sensor and a display being configured to display information to the user. The display comprises pixel elements being arranged in the display such that the pixel elements do not obscure a sensing area of the fingerprint sensor in which area the fingerprint sensor is being configured to detect a finger of the user.

Advantageously, the fingerprint sensing module according to embodiments enables a display being integrated with a fingerprint sensor, which has as an advantage that less space is required in the device in which it is integrated and also on a surface of the device, such as e.g. a smartcard.

Further, less components are required as compared to using a separate, non-integrated display. Advantageously, a reduced number of components to be integrated into the smartcard/device is a great advantage as regards simplification, yield loss reduction, supply chain complexity, etc.

Further advantageous is that the solution provided addresses that in particular capacitive fingerprint sensors, which are commonly used for integration with devices such as smartcards, are sensitive to disturbances of the capacitive signal caused by materials placed above the capacitive sensor elements of the fingerprint sensor.

Thus, with the solution provided with the fingerprint sensing module, the pixel elements of the display are not located directly above the sensor elements of the sensor.

In an embodiment, the fingerprint sensing module further comprises a substrate on which the display is arranged, the substrate further being configured to have an opening through which the fingerprint sensor is arranged to protrude into contact with the display.

In an embodiment, the fingerprint sensing module further comprises a substrate on which the display is arranged, the substrate is composed of a dielectric material (such as a polymer) with a dielectric constant suitable for transferring a capacitive fingerprint sensing signal from which the fingerprint sensor is capable of capturing biometric data of a finger of the user contacting the display.

In an alternative embodiment, the substrate is composed of a material having optical transparency suitable for transferring an optical fingerprint sensing signal from, or a material having acoustic impedance suitable for transferring an acoustic fingerprint sensing signal.

In an embodiment, the display is arranged to be screen-printed onto the substrate of the fingerprint sensing module.

In an embodiment, the fingerprint sensor of the fingerprint sensing module further comprises at least one connection point configured to connect the fingerprint sensor to the device in which it is integrated.

In an embodiment, the display of the fingerprint sensing module further comprises at least one connection point configured to connect the pixel elements of the display to the device in which it is integrated.

In embodiments, the device in which the fingerprint sensing module is integrated is a lock, electronic luggage tag, or a smartcard.

Many different applications may be envisaged, such as intelligent household appliances in the form of e.g. refrigerators, personalized settings for coffee machines, customizable settings for microwave ovens, or Internet-of-Things (IoT) devices, etc.

In a second aspect, a method of a device comprising the fingerprint sensing module according to the first aspect is provided for displaying information to a user based on biometric data of the user. The method comprises extracting biometric data of the user captured by the fingerprint sensor, comparing the extracted fingerprint feature data with enrolled biometric data, and if there is a match generating information based on the extracted biometric data, and displaying the generated information on the display of the fingerprint sensing module.

Advantageously, with the method of the second aspect, codes such as e.g. CVV codes can dynamically be generated by a smartcard and displayed to the user based on biometric data of the user.

In an embodiment, in case there is no match, the information is not generated and the method comprises displaying information indicating unsuccessful authentication on the display of the fingerprint sensing module.

In an embodiment, the generated information comprises a CVV code or CVC based on the biometric data, instructions to the user how to place her finger on the fingerprint sensing module during enrolment or authentication, or information regarding successful or unsuccessful authentication with the device, being for instance a smartcard.

In a conventional smartcard with biometric authentication, it is not possible to guide a user during the enrolment process. For instance, it may be desirable to guide the user during enrolment to slow down or speed up the process of having the finger repeatedly touch the sensor, rotate the finger, dry finger, notify the user of number of touches left for the enrolment, etc.

Hence, the display in the fingerprint sensing module provides for an improved and more user-friendly enrolment procedure, since the display can be used for guiding the user to be enrolled regarding, for example, finger position, finger rotation or sensor contamination, etc. This may provide for a faster enrolment procedure and/or a higher quality of the enrolled fingerprint representation.

In a third aspect, a computer program comprising computer-executable instructions is provided for causing the device comprising the fingerprint sensing module of the first aspect to perform steps recited in the method of the second aspect when the computer-executable instructions are executed on a processing unit included in the device.

In a fourth aspect, a computer program product comprising a computer readable medium is provided, the computer readable medium having the computer program according to the third aspect embodied thereon.

Further embodiments will be described in the following.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 schematically illustrates a smartcard comprising a bendable main body and a biometric sensor such as a fingerprint sensor for authorizing transactions carried out using the smart card;

FIG. 2 illustrates an enlarged view of the fingerprint sensor onto which a user places her finger;

FIG. 3 shows the fingerprint sensor being part of a fingerprint sensing system;

FIG. 4a illustrates a fingerprint sensing module of an embodiment;

FIG. 4b illustrates the fingerprint sensing module of FIG. 4a arranged in a smartcard for biometric authentication purposes;

FIG. 5a illustrates a fingerprint sensing module of an embodiment arranged in a smartcard for biometric authentication purposes;

FIG. 5b illustrates a fingerprint sensing module of another embodiment arranged in a smartcard for biometric authentication purposes;

FIG. 6a schematically illustrates the fingerprint sensing module only in a further embodiment;

FIG. 6b schematically illustrates the fingerprint sensing module only in yet a further embodiment;

FIG. 7 illustrates a user having her finger contact the display and thus the sensing area of the fingerprint sensor being arranged under the display of the smartcard in an embodiment;

FIG. 8 shows a flowchart illustrating a method of an embodiment of displaying information to a user by utilizing the fingerprint sensing module configured to be integrated in a smartcard; and

FIG. 9 is a schematic cross-section view of a portion of a fingerprint sensing system in which the fingerprint sensing module according to embodiments could be implemented.

### DETAILED DESCRIPTION

The aspects of the present disclosure will now be described more fully hereinafter with reference to the accompanying drawings, in which certain embodiments of the invention are shown.

These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

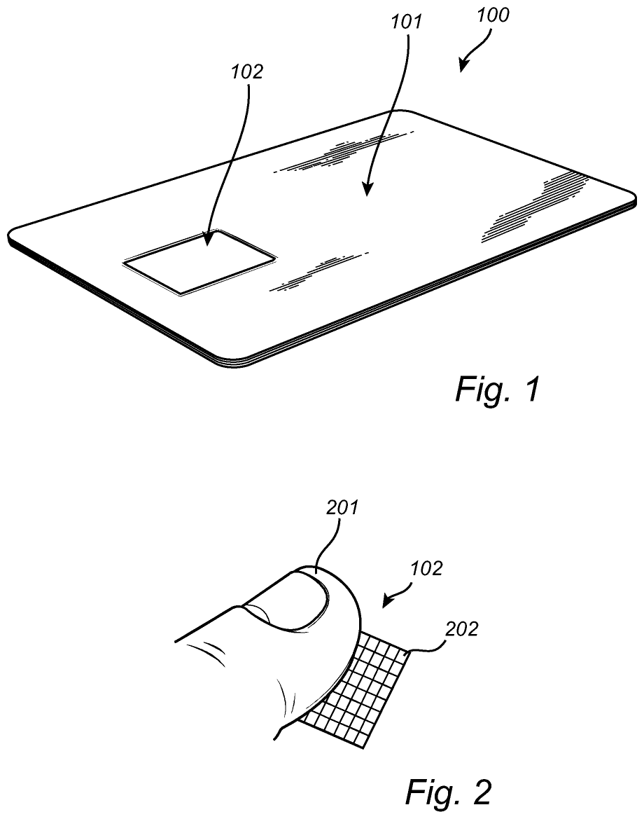

FIG. 1 schematically illustrates a smartcard 100 comprising a bendable main body 101 and a biometric sensor 102 such as a fingerprint sensor for authorizing transactions carried out using the smart card 100.

FIG. 2 illustrates a somewhat enlarged view of the fingerprint sensor 102 onto which a user places her finger 201. The fingerprint sensor 102 is configured to comprise a plurality of sensing elements. A single sensing element (also denoted as a pixel) is in FIG. 2 indicated by reference numeral 202.

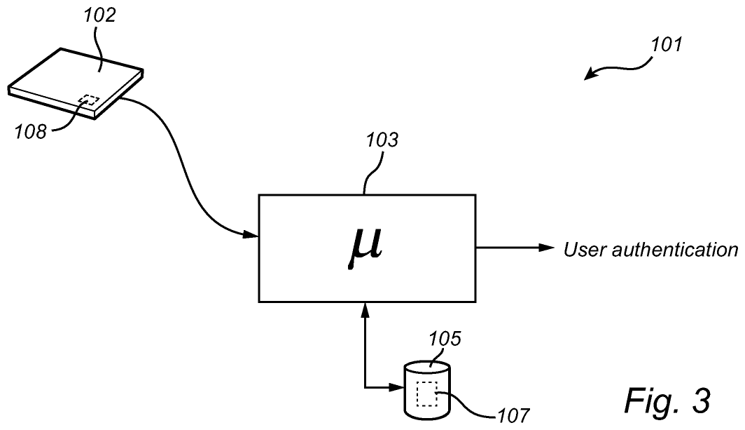

FIG. 3 shows the fingerprint sensor 102 being part of a fingerprint sensing system 11o. The fingerprint sensing system 11o comprises the fingerprint sensor 102 and a processing unit 103, such as a microprocessor, for controlling the fingerprint sensor 102 and for analysing captured fingerprints. The fingerprint sensing system 11o may further comprise a memory 105. The fingerprint sensing system 11o in turn, typically, forms part of the smartcard 100 as exemplified in FIG. 1. A local memory 108 such as a one-time programmable (OTP) memory, flash memory, or random-access memory (RAM) may be embedded in the sensor die. It is noted that the fingerprint sensor 102 is equipped with data processing capability but is typically far less powerful in terms of processing power as compared to the processing unit 103 (commonly referred to as the host processor).

Now, as previously discussed, assuming that the smartcard 100 further is to be provided with a display (not shown in FIG. 1) for instance for displaying a dynamically generated CVV code to the user, further space is required on an external surface of the smartcard 100, as well as inside the smart card 100.

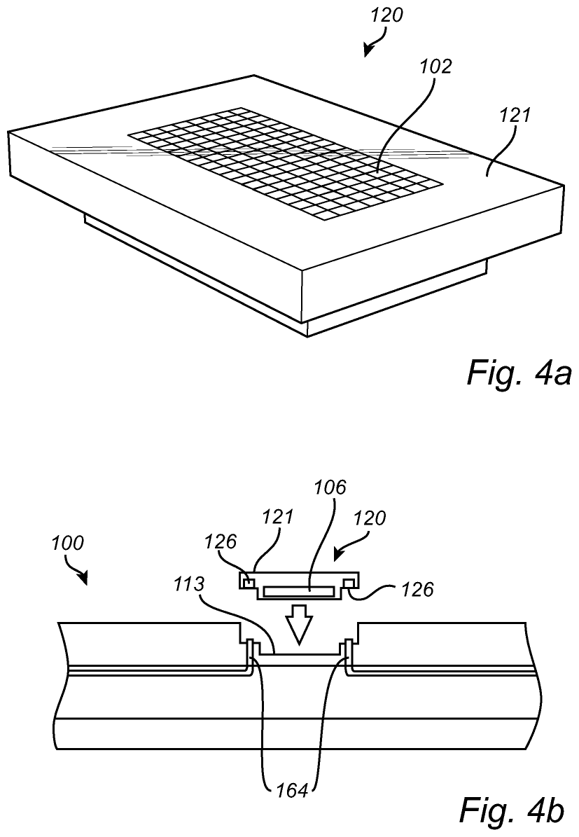

This is overcome by a fingerprint sensing module 120 of an embodiment schematically illustrated with reference to FIGS. 4a and 4b configured to be arranged in a device such as a smartcard 100 for biometric authentication purposes.

FIG. 4a is a schematic perspective view of the fingerprint sensing module 120. In this embodiment, the fingerprint sensing module 120 is T-shaped and comprises a display 121 seamlessly integrated with and surrounding a sensing area of a capacitive fingerprint sensor 102. In practice, the fingerprint sensor 102 comprises a sensor die pixel matrix 104 arranged in a protective housing structure commonly referred to as an overmold 106.

FIG. 4b illustrates the assembly of a T-shaped fingerprint sensing module 120 in a smart card 100. The smart card 100 comprises a recess 113 having an inverted T-shape corresponding to the T-shape of the fingerprint sensing module 120. The fingerprint sensing module 120 comprises some form of connection pads 126 in order to form an electrical connection with corresponding via connections 164 of the smart card 100. The fingerprint sensing module 120 may for instance be attached to the smartcard 100 using a conductive adhesive or a conductive solder material at the locations of the via connections 164.

Advantageously, with the fingerprint sensing module 120 illustrated in FIGS. 4a and b, a very compact solution is attained while providing a module 120 with display capability 121.

A fingerprint sensing module 120 of another embodiment is schematically illustrated with reference to Figure Sa configured to be arranged in a device such as a smartcard 100 for biometric authentication purposes. The fingerprint sensing module 120 comprises a display 121 (illustrated with dashed lines) seamlessly integrated with a capacitive fingerprint sensor 102 through a beneficial cover layer. Again, the fingerprint sensor 102 comprises a sensor die pixel matrix 104 arranged in an overmold 106 typically made of a plastic material and covered by for instance glass, a color coating, anti-fingerprint/hydrophobic/oleophobic coating, etc., for sensor protective reasons or for providing further functionality. Further, the fingerprint sensor 102 is placed on a printed circuit board 109 (PCB) inside the smart card 100.

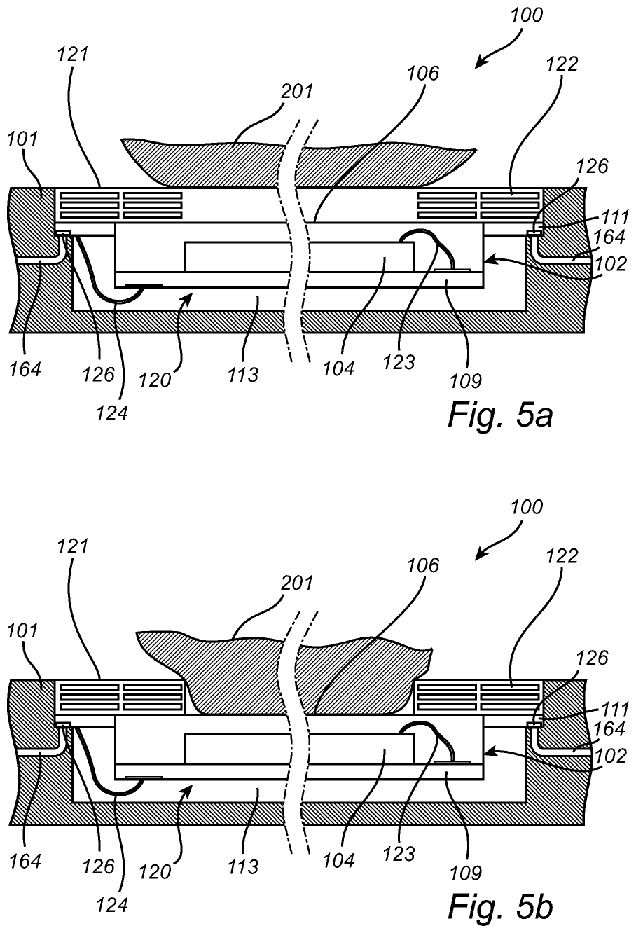

As further can be seen, the T-shaped fingerprint sensing module 120 is arranged in a recess 113 of the main body 101 of the smartcard 100. The upper plane of the display 121 may slightly protrude from an upper exterior plane of the main body 101, may be slightly embedded in the main body 101, or may be more or less flush with an upper exterior plane of the main body 101 (as illustrated in FIG. 5a). The display 121 is arranged on a substrate in (for instance a PCB) above the fingerprint sensor 102, which substrate in is configured with an opening through which the fingerprint sensor 102 protrudes into contact with the display 121. Thereby, the display 121 is brought into contact with a sensing area of the fingerprint sensor 102. Possibly the display 121 is attached to the sensor 102 by means of adhesive.

The fingerprint sensing module 120 comprises connection pads 126 in order to form an electrical connection with the via connections 164 of the smart card 100. The fingerprint sensing module 120 may for instance be attached to the smartcard 100 using a conductive adhesive or a conductive solder material at the locations of the via connections 164.

Moreover, the fingerprint die 104 is electrically connected to first substrate 109 via a bond wire 123 (even through-silicon-via (TSV) connections reaching through the first substrate 109 alternatively could be used) while the first substrate 109 is connected to substrate in via another bond wire 124 (and further on to the smartcard via the connection pads 126).

Pixel elements 122 of the display 121 are arranged inside the display such that they do not obscure the fingerprint sensor 102, or at least not a central area (referred to as sensing area) of the fingerprint sensor 102 where the fingerprint sensor capacitively detects a finger 201 of a user contacting an upper side of the display 121 and thus forms capacitive contact with the sensor 102 (i.e. the area directly above the die pixel matrix 104).

Advantageously, the fingerprint sensing module 120 according to the embodiment schematically illustrated with reference to FIG. 5a enables a display 121 being integrated with a fingerprint sensor 102, which has as an advantage that less space is required on the main body 101 of the smartcard 100.

Further advantageous is that the solution provided addresses that capacitive fingerprint sensors, which are commonly used for integration with devices such as smartcards, are sensitive to disturbances of the capacitive signal caused by materials placed above the capacitive sensor elements 202 of the fingerprint sensor 102.

Thus, with the solution provided with the fingerprint sensing module 120 of Figure Sa, the pixel elements 122 of the display 121 are not located directly above the capacitive sensor elements of the sensor 102, i.e. not located directly above the fingerprint sensing area. It is noted that other sensing technologies suitable for fingerprint sensing, such as optical and ultrasonic, also suffer from the above stated problems.

With further reference to Figure Sa, in an embodiment, the display 121 can be arranged on top of the sensor 102 by screen printing the display 121 on the substrate in.

In another embodiment, the display 121 can be arranged on top of the sensor 102 by screen printing the display 121 on the substrate in, which may be a thin flexible plastic substrate. If so, there is no need to arrange the fingerprint sensor 102 in an opening of the substrate 111; rather the fingerprint sensor 102 is arranged under the substrate in acting as a cover to the fingerprint sensor 102 without disturbing the sensor signal. The thin flexible plastic substrate in is composed of a dielectric polymer material with a dielectric constant suitable for transferring a capacitive signal from which biometric data is captured by the sensor 102 and may be transparent or opaque.

Alternatively, in case optical or acoustic sensing is utilized, the substrate in is composed of a material having optical transparency suitable for transferring an optical fingerprint sensing signal from which the fingerprint sensor 102 is capable of capturing biometric data of a finger of the user contacting the display 121, or the substrate in is composed of a material having acoustic impedance suitable for transferring an acoustic optical fingerprint sensing signal from which the fingerprint sensor 102 is capable of capturing biometric data of a finger of the user contacting the display 121.

Advantageously, the display 121 is a flexible reflective display, such as an electronic paper display or an electrochromic display.

FIG. 5b shows an alternative embodiment to that illustrated with reference to FIG. 5a, where the display 121 has an opening 112 where the user will insert her finger 201 in order to contact the sensing area of the fingerprint sensor 102. Thus, the display 121 is not necessarily arranged as a cover on top of the sensor 102.

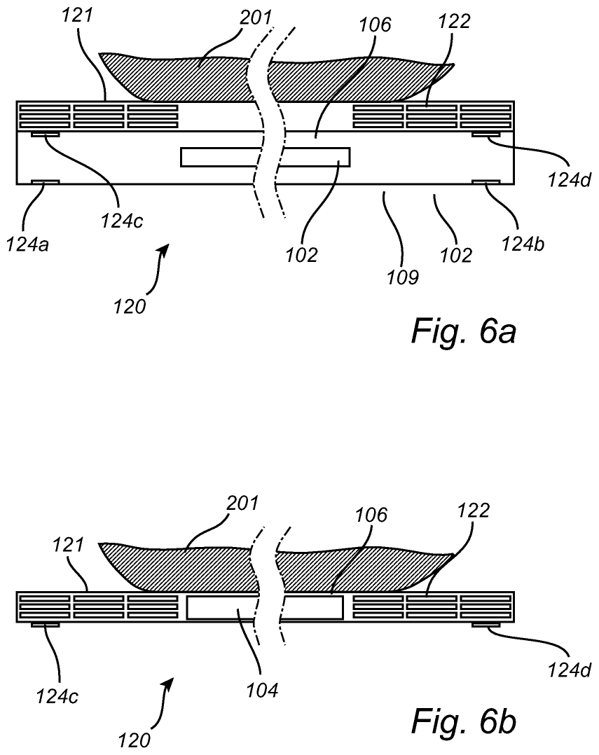

FIG. 6a illustrates a further embodiment schematically showing the fingerprint sensing module 120 only (not implemented in the smartcard 1oo), where any appropriate package type may be utilized. This has a different form factor than the previously described T-shape, and is inserted into a rectangular recess of the smart card in a similar way as the T-shaped module (being inserted in an inverted-T-shaped recess). In this embodiment, connection points 124a, 124b, i.e. terminals for carrying electric signals, to electronic components such as a power supply and/or the microprocessor 103 of FIG. 3 hosted by the device in which the fingerprint sensing module 120 is implemented are arranged on a bottom side of the module 120, in order to transmit fingerprint sensor signals to the microprocessor 103 for authenticating the user.

Moreover, another two connection points 124c, 124d are connected to a bottom side of the display 121 being embodied for instance by a protective cover film comprising pixel elements 121 not obscuring a sensing area of the fingerprint sensor 102. The two connection points 124c, 124d of the display 121 are also connected to e.g. the microprocessor 103 of the host device for controlling the pixel elements 122 of the display 121. For instance, the display 121 may be controlled by the microprocessor to notify the user that further enrolment of her fingerprint is required, to notify the user of successful authentication, or to display a new generated dynamic CVC.

FIG. 6b illustrates the fingerprint sensor comprising the sensor die 104 and a thin overmold 106 being arranged on a level with the display 121. Again, the connection points 124c, 124d are arranged to carry signals of the display 121 and the sensor die 104 to/from the device in which the module 120 is arranged.

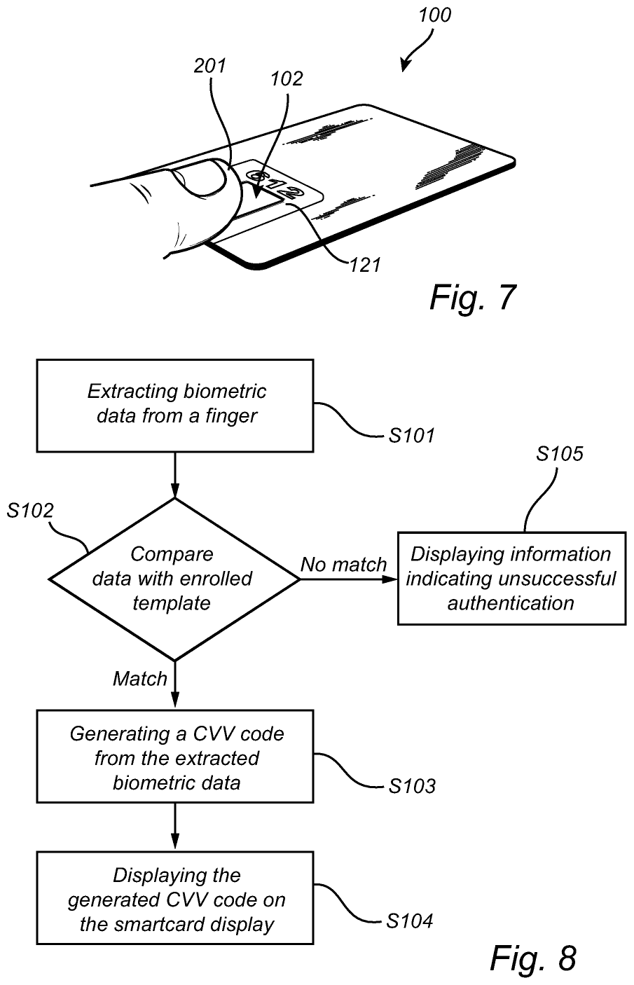

FIG. 7 illustrates a user having her finger 201 contact the sensing area of the fingerprint sensor 102 of the smartcard 100. The finger 201 of the user may establish sensing contact with the fingerprint sensor 102 using for instance capacitive, ultrasonic or optical sensing.

FIG. 8 shows a flowchart illustrating a method of displaying information to a user by utilizing the fingerprint sensing module 120 configured to be integrated in a device such as a smartcard 100 according to embodiments described hereinabove.

In this embodiment, the fingerprint sensor 102, or rather the microprocessor 103, extracts in step S101 biometric data from the finger 201 contacting the display 121 and the sensor 102 via the two connection points 124c, 124d. Hence, the fingerprint sensor 102 captures an image of the finger contacting the sensing area and the microprocessor 103 extracts the biometric data therefrom.

The extracted biometric data is compared by the microprocessor 103 in step S102 to one or more previously enrolled biometric data templates stored in memory 105 and if there is a match, the user is successfully authenticated.

Upon successful authentication, the processor 103 generates a CVV code utilizing the extracted biometric data in step S103, which CVV code is to be used by the user to perform for instance an Internet transaction. The CVV code may be generated for instance using a random value generator with the extracted biometric data, or a subset of the data, as a seed for generating the CVV code.

If the user is not successfully authenticated in step S102, no CVV code is generated. Rather, it is optionally envisaged that the microprocessor 103 in step S105 displays information to the user on the display 121 indicating that the user is not authentication, such as an “X” or even a blinking “X”.

In this particular exemplifying embodiment, the user is successfully authenticated in step S102, and the new CVV code generated in step S103 is “612” as displayed in step S104 to the user on the display 121 of the smartcard 100 by having the microprocessor 103 provide the CVV code to the display 121 and the pixel elements 122 via one or both of the two connection points 124c, 124d connected to the bottom side of the display 121.

As is understood, the new generated CVV code “612” is transmitted from the smartcard 100 to a party with which the user engages in the Internet transaction such that the party may verify correctness of the CVV code provided by the user during the transaction. Further, as has been discussed, any useful and appropriate information may be displayed to the user on the display 121, such as instructions for the user for placing her finger on the sensing area of the sensor during enrolment of a fingerprint of the user.

In a conventional smartcard with biometric authentication, it is not possible to guide a user during the enrolment process. For instance, it may be desirable to guide the user during enrolment to slow down or speed up the process of having the finger repeatedly touch the sensor, rotate the finger, dry finger, notify the user of number of touches left for the enrolment, etc.

Hence, the display 121 in the fingerprint sensing module 120 provides for an improved and more user-friendly enrolment procedure, since the display 121 can be used for guiding the user to be enrolled regarding, for example, finger position, finger rotation or sensor contamination, etc. This may provide for a faster enrolment procedure and/or a higher quality of the enrolled fingerprint representation. Thus, any useful enrolment instructions can be provided to the user via the display 121.

With reference again to FIG. 8, the steps of the method performed by the device 100 fingerprint sensing system 11o implemented in device 100 are in practice performed by the processing unit 103 embodied in the form of one or more microprocessors arranged to execute a computer program 107 downloaded to the storage medium 105 associated with the microprocessor, such as a Random Access Memory (RAM), a Flash memory or a hard disk drive. The processing unit 103 is arranged to cause the device 100 to carry out the method according to embodiments when the appropriate computer program 107 comprising computer-executable instructions is downloaded to the storage medium 105 and executed by the processing unit 103. The storage medium 105 may also be a computer program product comprising the computer program 107. Alternatively, the computer program 107 may be transferred to the storage medium 105 by means of a suitable computer program product, such as a Digital Versatile Disc (DVD) or a memory stick. As a further alternative, the computer program 107 maybe downloaded to the storage medium 105 over a network. The processing unit 103 may alternatively be embodied in the form of a digital signal processor (DSP), an application specific integrated circuit (ASIC), a field-programmable gate array (FPGA), a complex programmable logic device (CPLD), etc. It should further be understood that all or some parts of the functionality provided by means of the processing unit 103 may be at least partly integrated with the fingerprint sensor 102.

In the art, most fingerprint sensing modules comprise a bezel on top of the fingerprint sensing module to ground the finger of a user contacting the sensor. In such module, it would be difficult to also implement the display functionality due to the grounding bezel arranged on top of the sensor.

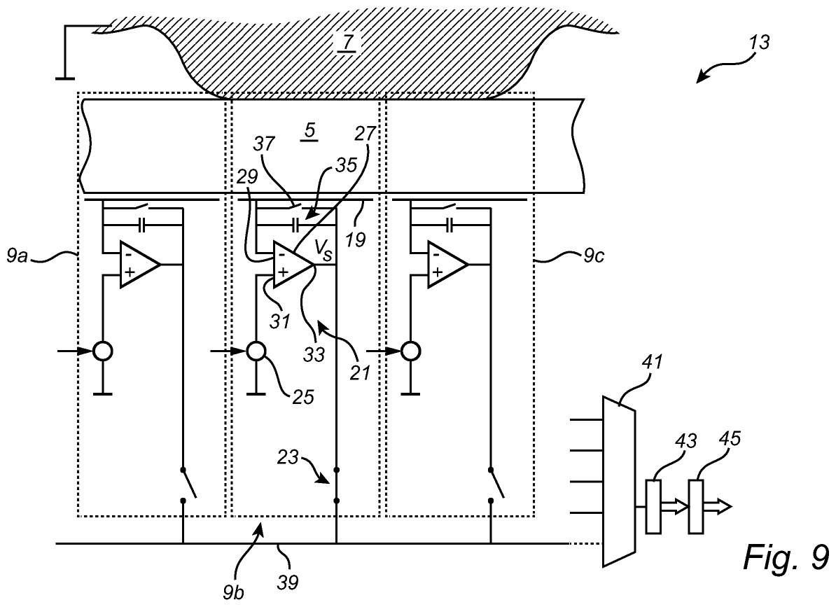

Therefore, the fingerprint sensing module 120 according to embodiments may advantageously be implemented using so-called swinging pixel technology, where no bezel is utilized. Such technology is illustrated with reference to FIG. 9.

FIG. 9 is a schematic cross-section view of a portion of a fingerprint sensing system, with a finger 7 placed on top of the measuring arrangement 13. The measuring arrangement 13 comprises a plurality of measuring elements 9a-c.

As is schematically shown in FIG. 9, each measuring element 9a-c (reference numerals are only indicated for one of the measuring elements to avoid cluttering the drawings) comprises a protective dielectric top layer 5, a conductive finger electrode 19 underneath the protective dielectric top layer 5, a charge amplifier 21, selection circuitry, here functionally illustrated as a simple selection switch 23 for allowing acquisition of a sensing signal from the measuring element 9a-c, and finger electrode potential providing circuitry 25 for controllably providing a selected electrical potential (constant or time-varying) to the finger electrode 19 as will be described in greater detail further below.

The charge amplifier 21 comprises at least one amplifier stage, here schematically illustrated as an operational amplifier (op amp) 27 having a first input (negative input) 29 connected to the finger electrode 19, a second input (positive input) 31 connected to the finger electrode potential providing circuitry 25, and an output 33. In addition, the charge amplifier 21 comprises a feedback capacitor 35 connected between the first input 29 and the output 33, and reset circuitry, here functionally illustrated as a switch 37, for allowing controllable discharge of the feedback capacitor 35. The charge amplifier 21 maybe reset by operating the reset circuitry 37 to discharge the feedback capacitor 35.

As is often the case for an op amp 27, the electrical potential at the first input 29 follows the electrical potential applied to the second input 31. Depending on the particular amplifier configuration, the potential at the first input 29 may be substantially the same as the potential at the second input 31, or there may be a substantially fixed offset between the potential at the first input 29 and the potential at the second input 31.

Using the finger electrode potential providing circuitry 25, a desired electrical potential, which may be time-varying or substantially constant in relation to a reference potential, can be provided to the finger electrode.

The finger electrode potential providing circuitry 25 may, for instance, be implemented as a number of controllable switches for controllably connecting the second input 31 to a selected voltage line carrying the desired electrical potential to be provided to the finger electrode. Alternatively, the finger electrode potential providing circuitry may be directly connectable to the finger electrode 19, to directly provide the desired electrical potential to the finger electrode.

Through control of the finger electrode potential providing circuitry 25, the finger electrode 19 can thus be provided with a chosen potential depending on the desired function of the particular measuring element 9 as will be described in greater detail further below.

When a given measuring element, say the center measuring element 9b in FIG. 9, is to function as a sensing measuring element, capable of providing a sensing signal indicating a capacitive coupling between the finger electrode of the sensing measuring element and the finger electrode of another measuring element, say either or both of the neighboring measuring elements 9a, 9c, the finger electrode potential providing circuitry 25 of the center measuring element 9b may, for example, be controlled to provide a substantially constant sensing finger electrode potential, in relation to a sensor ground potential, to the second input 31. At the same time, the finger electrode potential providing circuits of the neighboring measuring elements 9a, 9c may then be controlled to provide a different sensing finger electrode potential to the second inputs of the neighboring measuring elements 9a, 9c. This different sensing finger electrode potential maybe time-varying in relation to a sensor ground potential.

In FIG. 9, the finger 7 is schematically indicated as being “grounded”. It should be understood that the finger “ground” may be different from the sensor ground. For instance, the finger 7 maybe at the ground potential of the electronic device in which the fingerprint sensing system 3 is included. Alternatively, the body maybe considered to have such a large electrical “mass” that the potential of the finger remains substantially constant when the potential of a finger electrode 19 varies.

The above-described change in potential difference between the finger electrode 19 of the sensing measuring element 9b, and the finger electrodes of the neighboring measuring elements 9a, 9c, results in a sensing signal Vs on the output 33 of the charge amplifier 21.

When the indicated sensing element 9b is thus controlled to be a sensing measuring element, the selection switch 23 is closed to connect the output 33 of the charge amplifier 21 to the readout line 39. The readout line 39, which may be a common readout line for a row or a column of the 2D measuring arrangement 13, is shown in FIG. 9 to be connected to a multiplexer 41. As is schematically indicated in FIG. 9, additional readout lines providing sensing signals from other rows/columns of the measuring arrangement 13 are also connected to the multiplexer 41.

The sensing signals Vs from the sensing measuring element 9b are demodulated by sample-and-hold circuitry 43. The output of the sample-and-hold circuitry 43 is connected to an analog-to-digital converter 45 for converting the analog DC voltage signals output by the sample-and-hold circuitry to a digital representation of the measurement value for each selected sensing measuring element 9b.

By implementing the fingerprint sensing module according to embodiments using the structure illustrated in FIG. 9, with the display 121 arranged on top of the fingerprint sensor 102 such that the pixel elements 122 of the display 121 do not obscure the sensing area—i.e. the area formed by the sensing elements 202—of the fingerprint sensor 102, the space surrounding the sensor can be utilized to display information to the user since no grounding bezel is required.

The aspects of the present disclosure have mainly been described above with reference to a few embodiments and examples thereof. However, as is readily appreciated by a person skilled in the art, other embodiments than the ones disclosed above are equally possible within the scope of the invention, as defined by the appended patent claims.

Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A fingerprint sensing module configured to be integrated in a device for biometric authentication of a user of the device, comprising:
a fingerprint sensor;
a display configured to display information to the user; the display comprising pixel elements being arranged in the display such that the pixel elements do not obscure a sensing area of the fingerprint sensor in which area the fingerprint sensor is being configured to detect a finger of the user.

2. The fingerprint sensing module of claim 1, further comprising:
a substrate on which the display is arranged, the substrate further being configured to have an opening through which the fingerprint sensor is arranged to protrude into contact with the display.

3. The fingerprint sensing module of claim 1, further comprising:
a substrate on which the display is arranged, the substrate being composed of a dielectric material with a dielectric constant suitable for transferring a capacitive fingerprint sensing signal from which the fingerprint sensor is capable of capturing biometric data of a finger of the user contacting the display.

4. The fingerprint sensing module of claim 1, further comprising:
a substrate on which the display is arranged, the substrate being composed of a material having optical transparency suitable for transferring an optical fingerprint sensing signal from which the fingerprint sensor is capable of capturing biometric data of a finger of the user contacting the display, or the substrate being composed of a material having acoustic impedance suitable for transferring an acoustic fingerprint sensing signal from which the fingerprint sensor is capable of capturing biometric data of a finger of the user contacting the display, or the substrate being composed of a material having thermal transport properties suitable for transferring a thermal fingerprint sensing signal from which the fingerprint sensor is capable of capturing biometric data of a finger of the user contacting the display.

5. The fingerprint sensing module of claim 1, the display further being arranged to be screen-printed onto the substrate.

6. The fingerprint sensing module of claim 1, the fingerprint sensor further comprising:
at least one connection point configured to connect the fingerprint sensor to the device.

7. The fingerprint sensing module of claim 1, the display further comprising:
at least one connection point configured to connect the pixel elements of the display to the device.

8. The fingerprint sensing module of claim 1, the display being arranged on top of the fingerprint sensor and in contact with a sensing area of the fingerprint sensor in which the fingerprint sensor is being configured to detect a finger of the user contacting the display.

9. The fingerprint sensing module of claim 1, the display being arranged with an opening through which a finger of the user is configured to contact the fingerprint sensor.

10. The fingerprint sensing module of claim 1, wherein the device in which the fingerprint sensing module is integrated is a lock, electronic luggage tag, or a smartcard.

11. A method of a device comprising the fingerprint sensing module of claim 1 of displaying information to a user based on biometric data of the user, the method comprising:
extracting biometric data of the user captured by the fingerprint sensor;
comparing the extracted fingerprint feature data with enrolled biometric data, and if there is a match;
generating information based on the extracted biometric data; and
displaying the generated information on the display of the fingerprint sensing module.

12. The method of claim 11, wherein in case there is no match,
the information is not generated and the method comprises:
displaying information indicating unsuccessful authentication on the display of the fingerprint sensing module.

13. The method of claim 11, the generated information comprising a Card Verification Value, CVV, code or Card Verification Code, CVC, based on the biometric data, instructions to the user how to place her finger on the fingerprint sensing module during enrolment or authentication, or information regarding successful or unsuccessful authentication and/or enrolment with the device.

14. The method of claim 11, the device being a smartcard.

15. (canceled)

16. A computer program product comprising a non-transitory computer readable medium, the computer readable medium having a computer program embodied thereon, the computer program comprising computer-executable instructions for causing a fingerprint sensing system to perform the method of claim 11 when the computer-executable instructions are executed on a processing unit included in the fingerprint sensing system.
